(19) United States
(12) Patent Application Publication
(10) Pub. No.: US 2007/0106646 A1
(43) Pub. Date: May 10, 2007

(54) User-directed navigation of multimedia search results

(75) Inventors: Jeffrey Nathan Stern, Belmont, MA (US); Henry Houh, Lexington, MA (US); Robert Spina, Winchester, MA (US); Jian Jiang, Acton, MA (US)

Correspondence Address: PROSKAUER ROSE LLP, ONE INTERNATIONAL PLACE 14TH FL, BOSTON, MA, 02110, US

(73) Assignee: BBNT Solutions LLC, Cambridge, MA (US)

(21) Appl. No.: 11/395,732

(22) Filed: Mar. 31, 2006

Related U.S. Application Data
(60) Provisional application No. 60/736,124, filed on Nov. 9, 2005.

(51) Int. Cl. G06F 17/30

(52) U.S. Cl. 707/3

(57) ABSTRACT

According to one aspect, a computerized method and apparatus for generating and presenting search snippets that enable user-directed navigation of the underlying audio/video content. The method involves obtaining metadata associated with discrete media content that satisfies a search query. The metadata identifies a number of content segments and corresponding timing information derived from the underlying media content using one or more automated media processing techniques. Using the timing information identified in the metadata, a search result or “snippet” can be generated that enables a user to arbitrarily select and commence playback of the underlying media content at any of the individual content segments.

### RELATED APPLICATIONS

This application claims the benefit of U.S. Provisional Application No. 60/736,124, filed on Nov. 9, 2005. The entire teachings of the above application are incorporated herein by reference.

### FIELD OF THE INVENTION

Aspects of the invention relate to methods and apparatus for generating and using enhanced metadata in search-driven applications.

### BACKGROUND OF THE INVENTION

As the World Wide Web has emerged as a major research tool across all fields of study, the concept of metadata has become a crucial topic. Metadata, which can be broadly defined as “data about data,” refers to the searchable definitions used to locate information. This issue is particularly relevant to searches on the Web, where metatags may determine the ease with which a particular Web site is located by searchers. Metadata that are embedded with content is called embedded metadata. A data repository typically stores the metadata detached from the data.

Results obtained from search engine queries are limited to metadata information stored in a data repository, referred to as an index. With respect to media files or streams, the metadata information that describes the audio content or the video content is typically limited to information provided by the content publisher. For example, the metadata information associated with audio/video podcasts generally consists of a URL link to the podcast, title, and a brief summary of its content. If this limited information fails to satisfy a search query, the search engine is not likely to provide the corresponding audio/video podcast as a search result even if the actual content of the audio/video podcast satisfies the query.

### SUMMARY OF THE INVENTION

According to one aspect, the invention features an automated method and apparatus for generating metadata enhanced for audio, video or both (“audio/video”) search-driven applications. The apparatus includes a media indexer that obtains an media file or stream (“media file/stream”), applies one or more automated media processing techniques to the media file/stream, combines the results of the media processing into metadata enhanced for audio/video search, and stores the enhanced metadata in a searchable index or other data repository. The media file/stream can be an audio/video podcast, for example. By generating or otherwise obtaining such enhanced metadata that identifies content segments and corresponding timing information from the underlying media content, a number of for audio/video search-driven applications can be implemented as described herein. The term “media” as referred to herein includes audio, video or both.

According to another aspect, the invention features a computerized method and apparatus for generating search snippets that enable user-directed navigation of the underlying audio/video content. In order to generate a search snippet, metadata is obtained that is associated with discrete media content that satisfies a search query. The metadata identifies a number of content segments and corresponding timing information derived from the underlying media content using one or more automated media processing techniques. Using the timing information identified in the metadata, a search result or “snippet” can be generated that enables a user to arbitrarily select and commence playback of the underlying media content at any of the individual content segments. The method further includes downloading the search result to a client for presentation, further processing or storage.

According to one embodiment, the computerized method and apparatus includes obtaining metadata associated with the discrete media content that satisfies the search query such that the corresponding timing information includes offsets corresponding to each of the content segments within the discrete media content. The obtained metadata further includes a transcription for each of the content segments. A search result is generated that includes transcriptions of one or more of the content segments identified in the metadata with each of the transcriptions are mapped to an offset of a corresponding content segment. The search result is adapted to enable the user to arbitrarily select any of the one or more content segments for playback through user selection of one of the transcriptions provided in the search result and to cause playback of the discrete media content at an offset of a corresponding content segment mapped to the selected one of the transcriptions. The transcription for each of the content segments can be derived from the discrete media content using one or more automated media processing techniques or obtained from closed caption data associated with the discrete media content.

The search result can also be generated to further include a user actuated display element that uses the timing information to enable the user to navigate from an offset of one content segment to an offset of another content segment within the discrete media content in response to user actuation of the element.

The metadata can associate a confidence level with the transcription for each of the identified content segments. In such embodiments, the search result that includes transcriptions of one or more of the content segments identified in the metadata can be generated, such that each transcription having a confidence level that fails to satisfy a predefined threshold is displayed with one or more predefined symbols.

The metadata can associate a confidence level with the transcription for each of the identified content segments. In such embodiments, the search result can be ranked based on a confidence level associated with the corresponding content segment.

According to another embodiment, the computerized method and apparatus includes generating the search result to include a user actuated display element that uses the timing information to enables a user to navigate from an offset of one content segment to an offset of another content segment within the discrete media content in response to user actuation of the element. In such embodiments, metadata associated with the discrete media content that satisfies the search query can be obtained, such that the corresponding timing information includes offsets corresponding to each of the content segments within the discrete media content. The user actuated display element is adapted to respond to user actuation of the element by causing playback of the discrete media content commencing at one of the content segments having an offset that is prior to or subsequent to the offset of a content segment in presently playback.

In either embodiment, one or more of the content segments identified in the metadata can include word segments, audio speech segments, video segments, non-speech audio segments, or marker segments. For example, one or more of the content segments identified in the metadata can include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity. The one or more of the content segments identified in the metadata can also include video of individual scenes, watermarks, recognized objects, recognized faces, overlay text or video separated by markers embedded within the media content.

According to another aspect, the invention features a computerized method and apparatus for presenting search snippets that enable user-directed navigation of the underlying audio/video content. In particular embodiments, a search result is presented that enables a user to arbitrarily select and commence playback of the discrete media content at any of the content segments of the discrete media content using timing offsets derived from the discrete media content using one or more automated media processing techniques.

According to one embodiment, the search result is presented including transcriptions of one or more of the content segments of the discrete media content, each of the transcriptions being mapped to a timing offset of a corresponding content segment. A user selection is received of one of the transcriptions presented in the search result. In response, playback of the discrete media content is caused at a timing offset of the corresponding content segment mapped to the selected one of the transcriptions. Each of the transcriptions can be derived from the discrete media content using one or more automated media processing techniques or obtained from closed caption data associated with the discrete media content.

Each of the transcriptions can be associated with a confidence level. In such embodiment, the search result can be presented including the transcriptions of the one or more of the content segments of the discrete media content, such that any transcription that is associated with a confidence level that fails to satisfy a predefined threshold is displayed with one or more predefined symbols. The search result can also be presented to further include a user actuated display element that enables the user to navigate from an offset of one content segment to another content segment within the discrete media content in response to user actuation of the element.

According to another embodiment, the search result is presented including a user actuated display element that enables the user to navigate from an offset of one content segment to another content segment within the discrete media content in response to user actuation of the element. In such embodiments, timing offsets corresponding to each of the content segments within the discrete media content are obtained. In response to an indication of user actuation of the display element, a playback offset that is associated with the discrete media content in playback is determined. The playback offset is then compared with the timing offsets corresponding to each of the content segments to determine which of the content segments is presently in playback. Once the content segment is determined, playback of the discrete media content is caused to continue at an offset that is prior to or subsequent to the offset of the content segment presently in playback.

In either embodiment, one or more of the content segments identified in the metadata can include word segments, audio speech segments, video segments, non-speech audio segments, or marker segments. For example, one or more of the content segments identified in the metadata can include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity. The one or more of the content segments identified in the metadata can also include video of individual scenes, watermarks, recognized objects, recognized faces, overlay text or video separated by markers embedded within the media content.

### BRIEF DESCRIPTIONS OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a diagram illustrating an apparatus and method for generating metadata enhanced for audio/video search-driven applications.

FIG. 1B is a diagram illustrating an example of a media indexer.

FIG. 2 is a diagram illustrating an example of metadata enhanced for audio/video search-driven applications.

FIG. 3 is a diagram illustrating an example of a search snippet that enables user-directed navigation of underlying media content.

FIGS. 4 and 5 are diagrams illustrating a computerized method and apparatus for generating search snippets that enable user navigation of the underlying media content.

FIG. 6A is a diagram illustrating another example of a search snippet that enables user navigation of the underlying media content.

FIGS. 6B and 6C are diagrams illustrating a method for navigating media content using the search snippet of FIG. 6A.

### DETAILED DESCRIPTION

Generation of Enhanced Metadata for Audio/Video

The invention features an automated method and apparatus for generating metadata enhanced for audio/video search-driven applications. The apparatus includes a media indexer that obtains an media file/stream (e.g., audio/video podcasts), applies one or more automated media processing techniques to the media file/stream, combines the results of the media processing into metadata enhanced for audio/video search, and stores the enhanced metadata in a searchable index or other data repository.

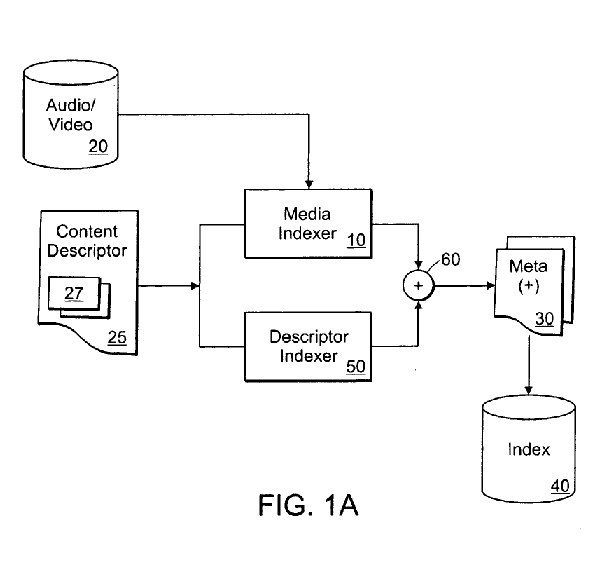

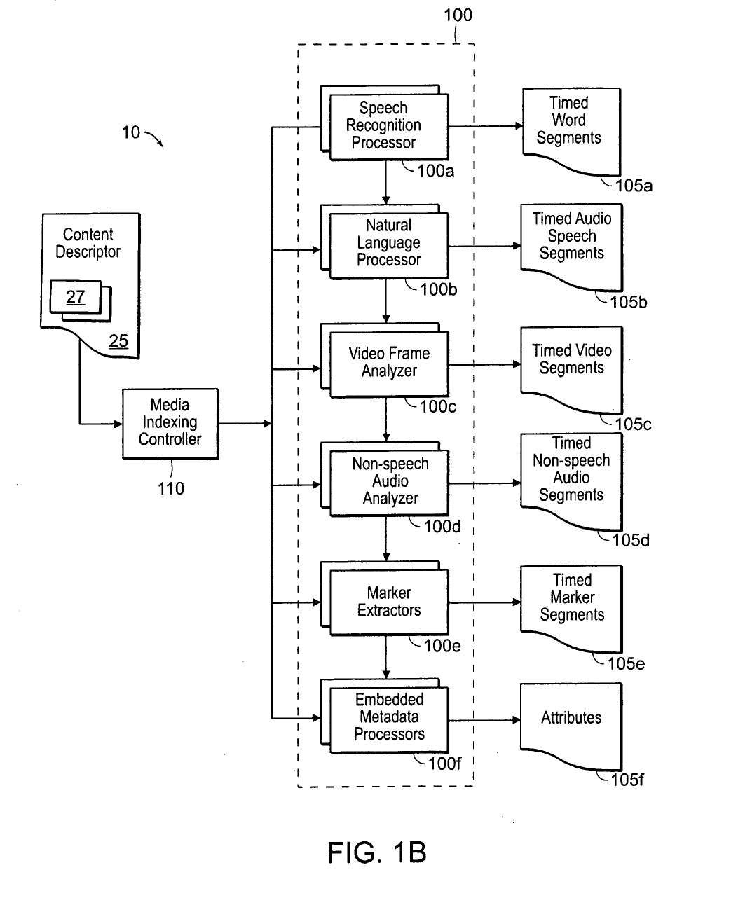

FIG. 1A is a diagram illustrating an apparatus and method for generating metadata enhanced for audio/video search-driven applications. As shown, the media indexer 10 cooperates with a descriptor indexer 50 to generate the enhanced metadata 30. A content descriptor 25 is received and processed by both the media indexer 10 and the descriptor indexer 50. For example, if the content descriptor 25 is a Really Simple Syndication (RSS) document, the metadata 27 corresponding to one or more audio/video podcasts includes a title, summary, and location (e.g., URL link) for each podcast. The descriptor indexer 50 extracts the descriptor metadata 27 from the text and embedded metatags of the content descriptor 25 and outputs it to a combiner 60. The content descriptor 25 can also be a simple web page link to a media file. The link can contain information in the text of the link that describes the file and can also include attributes in the HTML that describe the target media file.

In parallel, the media indexer 10 reads the metadata 27 from the content descriptor 25 and downloads the audio/video podcast 20 from the identified location. The media indexer 10 applies one or more automated media processing techniques to the downloaded podcast and outputs the combined results to the combiner 60. At the combiner 60, the metadata information from the media indexer 10 and the descriptor indexer 50 are combined in a predetermined format to form the enhanced metadata 30. The enhanced metadata 30 is then stored in the index 40 accessible to search-driven applications such as those disclosed herein.

In other embodiments, the descriptor indexer 50 is optional and the enhanced metadata is generated by the media indexer 10.

FIG. 1B is a diagram illustrating an example of a media indexer. As shown, the media indexer 10 includes a bank of media processors 100 that are managed by a media indexing controller 110. The media indexing controller 110 and each of the media processors 100 can be implemented, for example, using a suitably programmed or dedicated processor (e.g., a microprocessor or microcontroller), hardwired logic, Application Specific Integrated Circuit (ASIC), and a Programmable Logic Device (PLD) (e.g., Field Programmable Gate Array (FPGA)).

A content descriptor 25 is fed into the media indexing controller 110, which allocates one or more appropriate media processors 100a . . . 100n to process the media files/streams 20 identified in the metadata 27. Each of the assigned media processors 100 obtains the media file/stream (e.g., audio/video podcast) and applies a predefined set of audio or video processing routines to derive a portion of the enhanced metadata from the media content.

Examples of known media processors 100 include speech recognition processors 100a, natural language processors 100b, video frame analyzers 100c, non-speech audio analyzers 100d, marker extractors 100e and embedded metadata processors 100f. Other media processors known to those skilled in the art of audio and video analysis can also be implemented within the media indexer. The results of such media processing define timing boundaries of a number of content segment within a media file/stream, including timed word segments 105a, timed audio speech segments 105b, timed video segments 105c, timed non-speech audio segments 105d, timed marker segments 105e, as well as miscellaneous content attributes 105f, for example.

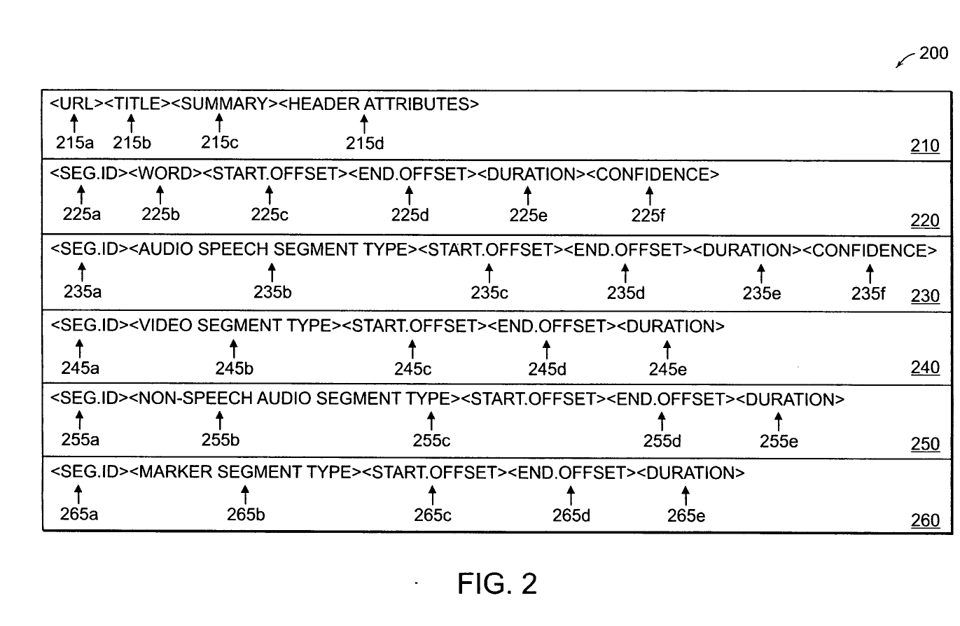

FIG. 2 is a diagram illustrating an example of metadata enhanced for audio/video search-driven applications. As shown, the enhanced metadata 200 include metadata 210 corresponding to the underlying media content generally. For example, where the underlying media content is an audio/video podcast, metadata 210 can include a URL 215a, title 215b, summary 215c, and miscellaneous content attributes 215d. Such information can be obtained from a content descriptor by the descriptor indexer 50. An example of a content descriptor is a Really Simple Syndication (RSS) document that is descriptive of one or more audio/video podcasts. Alternatively, such information can be extracted by an embedded metadata processor 100f from header fields embedded within the media file/stream according to a predetermined format.

The enhanced metadata 200 further identifies individual segments of audio/video content and timing information that defines the boundaries of each segment within the media file/stream. For example, in FIG. 2, the enhanced metadata 200 includes metadata that identifies a number of possible content segments within a typical media file/stream, namely word segments, audio speech segments, video segments, non-speech audio segments, and/or marker segments, for example.

The metadata 220 includes descriptive parameters for each of the timed word segments 225, including a segment identifier 225a, the text of an individual word 225b, timing information defining the boundaries of that content segment (i.e., start offset 225c, end offset 225d, and/or duration 225e), and optionally a confidence score 225f. The segment identifier 225a uniquely identifies each word segment amongst the content segments identified within the metadata 200. The text of the word segment 225b can be determined using a speech recognition processor 100a or parsed from closed caption data included with the media file/stream. The start offset 225c is an offset for indexing into the audio/video content to the beginning of the content segment. The end offset 225d is an offset for indexing into the audio/video content to the end of the content segment. The duration 225e indicates the duration of the content segment. The start offset, end offset and duration can each be represented as a timestamp, frame number or value corresponding to any other indexing scheme known to those skilled in the art. The confidence score 225f is a relative ranking (typically between 0 and 1) provided by the speech recognition processor 100a as to the accuracy of the recognized word.

The metadata 230 includes descriptive parameters for each of the timed audio speech segments 235, including a segment identifier 235a, an audio speech segment type 235b, timing information defining the boundaries of the content segment (e.g., start offset 235c, end offset 235d, and/or duration 235e), and optionally a confidence score 235f. The segment identifier 235a uniquely identifies each audio speech segment amongst the content segments identified within the metadata 200. The audio speech segment type 235b can be a numeric value or string that indicates whether the content segment includes audio corresponding to a phrase, a sentence, a paragraph, story or topic, particular gender, and/or an identified speaker. The audio speech segment type 235b and the corresponding timing information can be obtained using a natural language processor 100b capable of processing the timed word segments from the speech recognition processors 100a and/or the media file/stream 20 itself. The start offset 235c is an offset for indexing into the audio/video content to the beginning of the content segment. The end offset 235d is an offset for indexing into the audio/video content to the end of the content segment. The duration 235e indicates the duration of the content segment. The start offset, end offset and duration can each be represented as a timestamp, frame number or value corresponding to any other indexing scheme known to those skilled in the art. The confidence score 235f can be in the form of a statistical value (e.g., average, mean, variance, etc.) calculated from the individual confidence scores 225f of the individual word segments.

The metadata 240 includes descriptive parameters for each of the timed video segments 245, including a segment identifier 225a, a video segment type 245b, and timing information defining the boundaries of the content segment (e.g., start offset 245c, end offset 245d, and/or duration 245e). The segment identifier 245a uniquely identifies each video segment amongst the content segments identified within the metadata 200. The video segment type 245b can be a numeric value or string that indicates whether the content segment corresponds to video of an individual scene, watermark, recognized object, recognized face, or overlay text. The video segment type 245b and the corresponding timing information can be obtained using a video frame analyzer 100c capable of applying one or more image processing techniques. The start offset 235c is an offset for indexing into the audio/video content to the beginning of the content segment. The end offset 235d is an offset for indexing into the audio/video content to the end of the content segment. The duration 235e indicates the duration of the content segment. The start offset, end offset and duration can each be represented as a timestamp, frame number or value corresponding to any other indexing scheme known to those skilled in the art.

The metadata 250 includes descriptive parameters for each of the timed non-speech audio segments 255 include a segment identifier 225a, a non-speech audio segment type 255b, and timing information defining the boundaries of the content segment (e.g., start offset 255c, end offset 255d, and/or duration 255e). The segment identifier 255a uniquely identifies each non-speech audio segment amongst the content segments identified within the metadata 200. The audio segment type 235b can be a numeric value or string that indicates whether the content segment corresponds to audio of non-speech sounds, audio associated with a speaker emotion, audio within a range of volume levels, or sound gaps, for example. The non-speech audio segment type 255b and the corresponding timing information can be obtained using a non-speech audio analyzer 100d. The start offset 255c is an offset for indexing into the audio/video content to the beginning of the content segment. The end offset 255d is an offset for indexing into the audio/video content to the end of the content segment. The duration 255e indicates the duration of the content segment. The start offset, end offset and duration can each be represented as a timestamp, frame number or value corresponding to any other indexing scheme known to those skilled in the art.

The metadata 260 includes descriptive parameters for each of the timed marker segments 265, including a segment identifier 265a, a marker segment type 265b, timing information defining the boundaries of the content segment (e.g., start offset 265c, end offset 265d, and/or duration 265e). The segment identifier 265a uniquely identifies each video segment amongst the content segments identified within the metadata 200. The marker segment type 265b can be a numeric value or string that can indicates that the content segment corresponds to a predefined chapter or other marker within the media content (e.g., audio/video podcast). The marker segment type 265b and the corresponding timing information can be obtained using a marker extractor 100e to obtain metadata in the form of markers (e.g., chapters) that are embedded within the media content in a manner known to those skilled in the art.

By generating or otherwise obtaining such enhanced metadata that identifies content segments and corresponding timing information from the underlying media content, a number of for audio/video search-driven applications can be implemented as described herein.

Audio/Video Search Snippets

According to another aspect, the invention features a computerized method and apparatus for generating and presenting search snippets that enable user-directed navigation of the underlying audio/video content. The method involves obtaining metadata associated with discrete media content that satisfies a search query. The metadata identifies a number of content segments and corresponding timing information derived from the underlying media content using one or more automated media processing techniques. Using the timing information identified in the metadata, a search result or “snippet” can be generated that enables a user to arbitrarily select and commence playback of the underlying media content at any of the individual content segments.

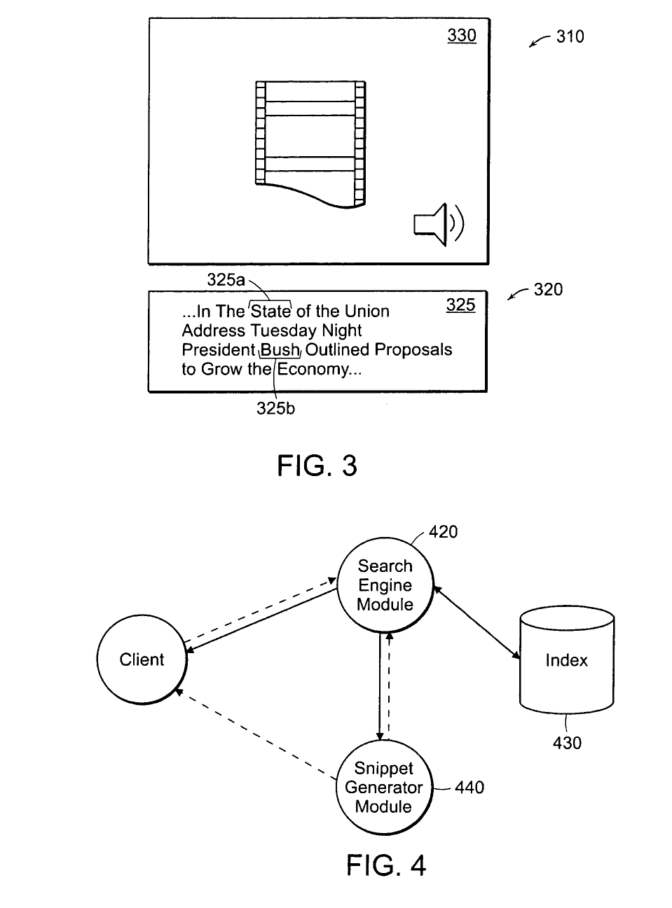

FIG. 3 is a diagram illustrating an example of a search snippet that enables user-directed navigation of underlying media content. The search snippet 310 includes a text area 320 displaying the text 325 of the words spoken during one or more content segments of the underlying media content. A media player 330 capable of audio/video playback is embedded within the search snippet or alternatively executed in a separate window.

The text 325 for each word in the text area 320 is preferably mapped to a start offset of a corresponding word segment identified in the enhanced metadata. For example, an object (e.g. SPAN object) can be defined for each of the displayed words in the text area 320. The object defines a start offset of the word segment and an event handler. Each start offset can be a timestamp or other indexing value that identifies the start of the corresponding word segment within the media content. Alternatively, the text 325 for a group of words can be mapped to the start offset of a common content segment that contains all of those words. Such content segments can include a audio speech segment, a video segment, or a marker segment, for example, as identified in the enhanced metadata of FIG. 2.

Playback of the underlying media content occurs in response to the user selection of a word and begins at the start offset corresponding to the content segment mapped to the selected word or group of words. User selection can be facilitated, for example, by directing a graphical pointer over the text area 320 using a pointing device and actuating the pointing device once the pointer is positioned over the text 325 of a desired word. In response, the object event handler provides the media player 330 with a set of input parameters, including a link to the media file/stream and the corresponding start offset, and directs the player 330 to commence or otherwise continue playback of the underlying media content at the input start offset.

For example, referring to FIG. 3, if a user clicks on the word 325a, the media player 330 begins to plays back the media content at the audio/video segment starting with “state of the union address . . . ” Likewise, if the user clicks on the word 325b, the media player 330 commences playback of the audio/video segment starting with “bush outlined . . . ”

An advantage of this aspect of the invention is that a user can read the text of the underlying audio/video content displayed by the search snippet and then actively “jump to” a desired segment of the media content for audio/video playback without having to listen to or view the entire media stream.

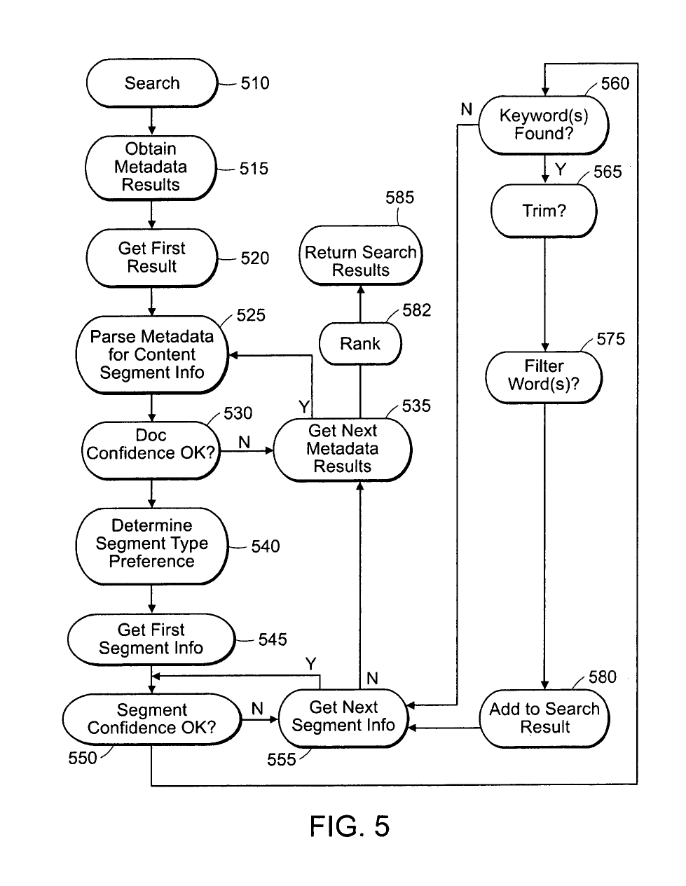

FIGS. 4 and 5 are diagrams illustrating a computerized method and apparatus for generating search snippets that enable user navigation of the underlying media content. Referring to FIG. 4, a client 410 interfaces with a search engine module 420 for searching an index 430 for desired audio/video content. The index includes a plurality of metadata associated with a number of discrete media content and enhanced for audio/video search as shown and described with reference to FIG. 2. The search engine module 420 also interfaces with a snippet generator module 440 that processes metadata satisfying a search query to generate the navigable search snippet for audio/video content for the client 410. Each of these modules can be implemented, for example, using a suitably programmed or dedicated processor (e.g., a microprocessor or microcontroller), hardwired logic, Application Specific Integrated Circuit (ASIC), and a Programmable Logic Device (PLD) (e.g., Field Programmable Gate Array (FPGA)).

FIG. 5 is a flow diagram illustrating a computerized method for generating search snippets that enable user-directed navigation of the underlying audio/video content. At step 510, the search engine 420 conducts a keyword search of the index 430 for a set of enhanced metadata documents satisfying the search query. At step 515, the search engine 420 obtains the enhanced metadata documents descriptive of one or more discrete media files/streams (e.g., audio/video podcasts).

At step 520, the snippet generator 440 obtains an enhanced metadata document corresponding to the first media file/stream in the set. As previously discussed with respect to FIG. 2, the enhanced metadata identifies content segments and corresponding timing information defining the boundaries of each segment within the media file/stream.

At step 525, the snippet generator 440 reads or parses the enhanced metadata document to obtain information on each of the content segments identified within the media file/stream. For each content segment, the information obtained preferably includes the location of the underlying media content (e.g. URL), a segment identifier, a segment type, a start offset, an end offset (or duration), the word or the group of words spoken during that segment, if any, and an optional confidence score.

Step 530 is an optional step in which the snippet generator 440 makes a determination as to whether the information obtained from the enhanced metadata is sufficiently accurate to warrant further search and/or presentation as a valid search snippet. For example, as shown in FIG. 2, each of the word segments 225 includes a confidence score 225f assigned by the speech recognition processor 100a. Each confidence score is a relative ranking (typically between 0 and 1) as to the accuracy of the recognized text of the word segment. To determine an overall confidence score for the enhanced metadata document in its entirety, a statistical value (e.g., average, mean, variance, etc.) can be calculated from the individual confidence scores of all the word segments 225.

Thus, if, at step 530, the overall confidence score falls below a predetermined threshold, the enhanced metadata document can be deemed unacceptable from which to present any search snippet of the underlying media content. Thus, the process continues at steps 535 and 525 to obtain and read/parse the enhanced metadata document corresponding to the next media file/stream identified in the search at step 510. Conversely, if the confidence score for the enhanced metadata in its entirety equals or exceeds the predetermined threshold, the process continues at step 540.

At step 540, the snippet generator 440 determines a segment type preference. The segment type preference indicates which types of content segments to search and present as snippets. The segment type preference can include a numeric value or string corresponding to one or more of the segment types. For example, if the segment type preference can be defined to be one of the audio speech segment types, e.g., “story,” the enhanced metadata is searched on a story-by-story basis for a match to the search query and the resulting snippets are also presented on a story-by-story basis. In other words, each of the content segments identified in the metadata as type “story” are individually searched for a match to the search query and also presented in a separate search snippet if a match is found. Likewise, the segment type preference can alternatively be defined to be one of the video segment types, e.g., individual scene. The segment type preference can be fixed programmatically or user configurable.

At step 545, the snippet generator 440 obtains the metadata information corresponding to a first content segment of the preferred segment type (e.g., the first story segment). The metadata information for the content segment preferably includes the location of the underlying media file/stream, a segment identifier, the preferred segment type, a start offset, an end offset (or duration) and an optional confidence score. The start offset and the end offset/duration define the timing boundaries of the content segment. By referencing the enhanced metadata, the text of words spoken during that segment, if any, can be determined by identifying each of the word segments falling within the start and end offsets. For example, if the underlying media content is an audio/video podcast of a news program and the segment preference is “story,” the metadata information for the first content segment includes the text of the word segments spoken during the first news story.

Step 550 is an optional step in which the snippet generator 440 makes a determination as to whether the metadata information for the content segment is sufficiently accurate to warrant further search and/or presentation as a valid search snippet. This step is similar to step 530 except that the confidence score is a statistical value (e.g., average, mean, variance, etc.) calculated from the individual confidence scores of the word segments 225 falling within the timing boundaries of the content segment.

If the confidence score falls below a predetermined threshold, the process continues at step 555 to obtain the metadata information corresponding to a next content segment of the preferred segment type. If there are no more content segments of the preferred segment type, the process continues at step 535 to obtain the enhanced metadata document corresponding to the next media file/stream identified in the search at step 510. Conversely, if the confidence score of the metadata information for the content segment equals or exceeds the predetermined threshold, the process continues at step 560.

At step 560, the snippet generator 440 compares the text of the words spoken during the selected content segment, if any, to the keyword(s) of the search query. If the text derived from the content segment does not contain a match to the keyword search query, the metadata information for that segment is discarded. Otherwise, the process continues at optional step 565.

At optional step 565, the snippet generator 440 trims the text of the content segment (as determined at step 545) to fit within the boundaries of the display area (e.g., text area 320 of FIG. 3). According to one embodiment, the text can be trimmed by locating the word(s) matching the search query and limiting the number of additional words before and after. According to another embodiment, the text can be trimmed by locating the word(s) matching the search query, identifying another content segment that has a duration shorter than the segment type preference and contains the matching word(s), and limiting the displayed text of the search snippet to that of the content segment of shorter duration. For example, assuming that the segment type preference is of type “story,” the displayed text of the search snippet can be limited to that of segment type “sentence” or “paragraph”.

At optional step 575, the snippet generator 440 filters the text of individual words from the search snippet according to their confidence scores. For example, in FIG. 2, a confidence score 225f is assigned to each of the word segments to represent a relative ranking that corresponds to the accuracy of the text of the recognized word. For each word in the text of the content segment, the confidence score from the corresponding word segment 225 is compared against a predetermined threshold value. If the confidence score for a word segment falls below the threshold, the text for that word segment is replaced with a predefined symbol (e.g., - - - ). Otherwise no change is made to the text for that word segment.

At step 580, the snippet generator 440 adds the resulting metadata information for the content segment to a search result for the underlying media stream/file. Each enhanced metadata document that is returned from the search engine can have zero, one or more content segments containing a match to the search query. Thus, the corresponding search result associated with the media file/stream can also have zero, one or more search snippets associated with it. An example of a search result that includes no search snippets occurs when the metadata of the original content descriptor contains the search term, but the timed word segments 105a of FIG. 2 do not.

The process returns to step 555 to obtain the metadata information corresponding to the next content snippet segment of the preferred segment type. If there are no more content segments of the preferred segment type, the process continues at step 535 to obtain the enhanced metadata document corresponding to the next media file/stream identified in the search at step 510. If there are no further metadata results to process, the process continues at optional step 582 to rank the search results before sending to the client 410.

At optional step 582, the snippet generator 440 ranks and sorts the list of search results. One factor for determining the rank of the search results can include confidence scores. For example, the search results can be ranked by calculating the sum, average or other statistical value from the confidence scores of the constituent search snippets for each search result and then ranking and sorting accordingly. Search results being associated with higher confidence scores can be ranked and thus sorted higher than search results associated with lower confidence scores. Other factors for ranking search results can include the publication date associated with the underlying media content and the number of snippets in each of the search results that contain the search term or terms. Any number of other criteria for ranking search results known to those skilled in the art can also be utilized in ranking the search results for audio/video content.

At step 585, the search results can be returned in a number of different ways. According to one embodiment, the snippet generator 440 can generate a set of instructions for rendering each of the constituent search snippets of the search result as shown in FIG. 3, for example, from the raw metadata information for each of the identified content segments. Once the instructions are generated, they can be provided to the search engine 420 for forwarding to the client. If a search result includes a long list of snippets, the client can display the search result such that a few of the snippets are displayed along with an indicator that can be selected to show the entire set of snippets for that search result.

Although not so limited, such a client includes (i) a browser application that is capable of presenting graphical search query forms and resulting pages of search snippets; (ii) a desktop or portable application capable of, or otherwise modified for, subscribing to a service and receiving alerts containing embedded search snippets (e.g., RSS reader applications); or (iii) a search applet embedded within a DVD (Digital Video Disc) that allows users to search a remote or local index to locate and navigate segments of the DVD audio/video content.

According to another embodiment, the metadata information contained within the list of search results in a raw data format are forwarded directly to the client 410 or indirectly to the client 410 via the search engine 420. The raw metadata information can include any combination of the parameters including a segment identifier, the location of the underlying content (e.g., URL or filename), segment type, the text of the word or group of words spoken during that segment (if any), timing information (e.g., start offset, end offset, and/or duration) and a confidence score (if any). Such information can then be stored or further processed by the client 410 according to application specific requirements. For example, a client desktop application, such as iTunes Music Store available from Apple Computer, Inc., can be modified to process the raw metadata information to generate its own proprietary user interface for enabling user-directed navigation of media content, including audio/video podcasts, resulting from a search of its Music Store repository.

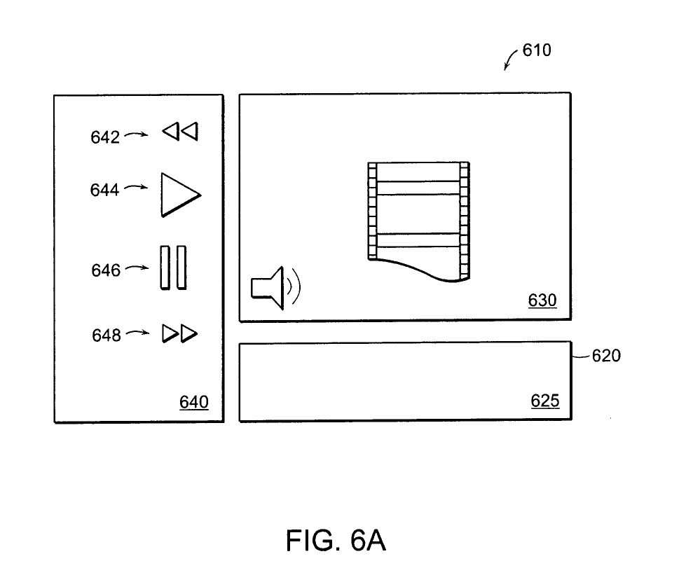

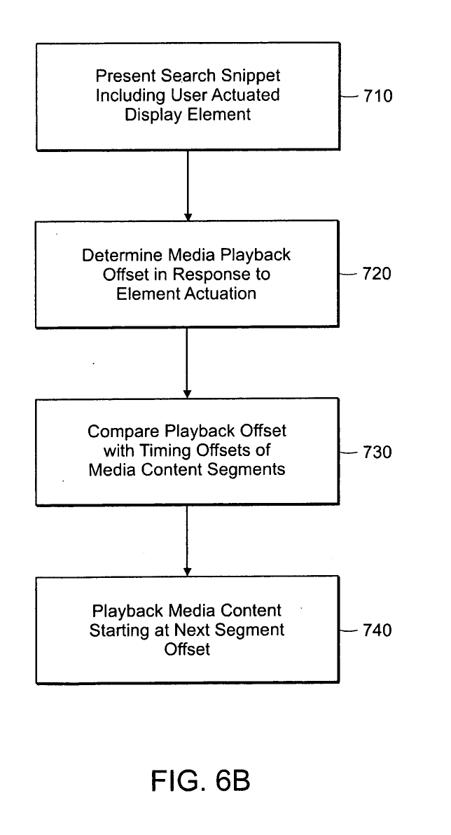

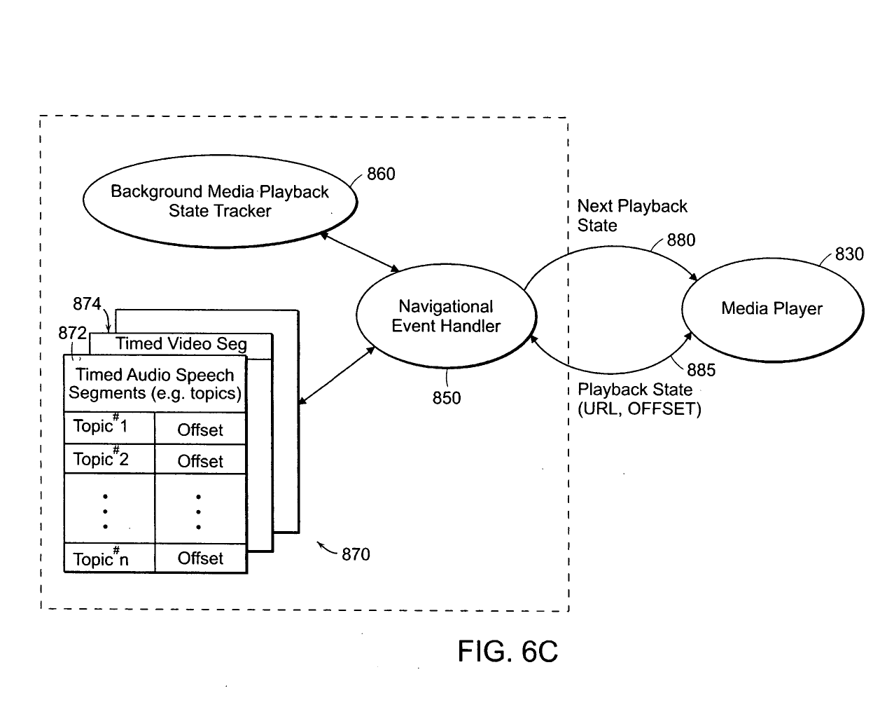

FIG. 6A is a diagram illustrating another example of a search snippet that enables user navigation of the underlying media content. The search snippet 610 is similar to the snippet described with respect to FIG. 3, and additionally includes a user actuated display element 640 that serves as a navigational control. The navigational control 640 enables a user to control playback of the underlying media content. The text area 620 is optional for displaying the text 625 of the words spoken during one or more segments of the underlying media content as previously discussed with respect to FIG. 3.

Typical fast forward and fast reverse functions cause media players to jump ahead or jump back during media playback in fixed time increments. In contrast, the navigational control 640 enables a user to jump from one content segment to another segment using the timing information of individual content segments identified in the enhanced metadata.

As shown in FIG. 6A, the user-actuated display element 640 can include a number of navigational controls (e.g., Back 642, Forward 648, Play 644, and Pause 646). The Back 642 and Forward 648 controls can be configured to enable a user to jump between word segments, audio speech segments, video segments, non-speech audio segments, and marker segments. For example, if an audio/video podcast includes several content segments corresponding to different stories or topics, the user can easily skip such segments until the desired story or topic segment is reached.

FIGS. 6B and 6C are diagrams illustrating a method for navigating media content using the search snippet of FIG. 6A. At step 710, the client presents the search snippet of FIG. 6A, for example, that includes the user actuated display element 640. The user-actuated display element 640 includes a number of individual navigational controls (i.e., Back 642, Forward 648, Play 644, and Pause 646). Each of the navigational controls 642, 644, 646, 648 is associated with an object defining at least one event handler that is responsive to user actuations. For example, when a user clicks on the Play control 644, the object event handler provides the media player 630 with a link to the media file/stream and directs the player 630 to initiate playback of the media content from the beginning of the file/stream or from the most recent playback offset.

At step 720, in response to an indication of user actuation of Forward 648 and Back 642 display elements, a playback offset associated with the underlying media content in playback is determined. The playback offset can be a timestamp or other indexing value that varies according to the content segment presently in playback. This playback offset can be determined by polling the media player or by autonomously tracking the playback time.

For example, as shown in FIG. 6C, when the navigational event handler 850 is triggered by user actuation of the Forward 648 or Back 642 control elements, the playback state of media player module 830 is determined from the identity of the media file/stream presently in playback (e.g., URL or filename), if any, and the playback timing offset. Determination of the playback state can be accomplished by a sequence of status request/response 855 signaling to and from the media player module 830. Alternatively, a background media playback state tracker module 860 can be executed that keeps track of the identity of the media file in playback and maintains a playback clock (not shown) that tracks the relative playback timing offsets.

At step 730 of FIG. 6B, the playback offset is compared with the timing information corresponding to each of the content segments of the underlying media content to determine which of the content segments is presently in playback. As shown in FIG. 6C, once the media file/stream and playback timing offset are determined, the navigational event handler 850 references a segment list 870 that identifies each of the content segments in the media file/stream and the corresponding timing offset of that segment. As shown, the segment list 870 includes a segment list 872 corresponding to a set of timed audio speech segments (e.g., topics). For example, if the media file/stream is an audio/video podcast of an episode of a daily news program, the segment list 872 can include a number of entries corresponding to the various topics discussed during that episode (e.g., news, weather, sports, entertainment, etc.) and the time offsets corresponding to the start of each topic. The segment list 870 can also include a video segment list 874 or other lists (not shown) corresponding to timed word segments, timed non-speech audio segments, and timed marker segments, for example. The segment lists 870 can be derived from the enhanced metadata or can be the enhanced metadata itself.

At step 740 of FIG. 6B, the underlying media content is played back at an offset that is prior to or subsequent to the offset of the content segment presently in playback. For example, referring to FIG. 6C, the event handler 850 compares the playback timing offset to the set of predetermined timing offsets in one or more of the segment lists 870 to determine which of the content segments to playback next. For example, if the user clicked on the “forward” control 848, the event handler 850 obtains the timing offset for the content segment that is greater in time than the present playback offset. Conversely, if the user clicks on the “backward” control 842, the event handler 850 obtains the timing offset for the content segment that is earlier in time than the present playback offset. After determining the timing offset of the next segment to play, the event handler 850 provides the media player module 830 with instructions 880 directing playback of the media content at the next playback state (e.g., segment offset and/or URL).

Thus, an advantage of this aspect of the invention is that a user can control media using a client that is capable of jumping from one content segment to another segment using the timing information of individual content segments identified in the enhanced metadata. One particular application of this technology can be applied to portable player devices, such as the iPod audio/video player available from Apple Computer, Inc. For example, after downloading a podcast to the iPod, it is unacceptable for a user to have to listen to or view an entire podcast if he/she is only interested in a few segments of the content. Rather, by modifying the internal operating system software of iPod, the control buttons on the front panel of the iPod can be used to jump from one segment to the next segment of the podcast in a manner similar to that previously described.

While this invention has been particularly shown and described with references to preferred embodiments thereof, it will be understood by those skilled in the art that various changes in form and details may be made therein without departing from the scope of the invention encompassed by the appended claims.

What is claimed:

1. A computerized method of generating search results for media content, comprising:
obtaining metadata associated with a discrete media content that satisfies a search query, the metadata identifying content segments and corresponding timing information derived from the discrete media content using one or more automated media processing techniques; and
generating a search result that enables a user to arbitrarily select and commence playback of the discrete media content at any of the content segments using the corresponding timing information identified in the metadata.

2. The computerized method of claim 1 further comprising:
obtaining the metadata associated with the discrete media content that satisfies the search query, the corresponding timing information including offsets corresponding to each of the content segments within the discrete media content, and the metadata further including a transcription for each of the content segments;
generating the search result that includes transcriptions of one or more of the content segments identified in the metadata, each of the transcriptions being mapped to an offset of a corresponding content segment; and
adapting the search result to enable the user to arbitrarily select any of the one or more content segments for playback through user selection of one of the transcriptions provided in the search result and to cause playback of the discrete media content at an offset of a corresponding content segment mapped to the selected one of the transcriptions.

3. The method of claim 2 wherein the transcription for each of the content segments is derived from the discrete media content using one or more automated media processing techniques or obtained from closed caption data associated with the discrete media content.

4. The computerized method of claim 2 further comprising:
generating the search result to further include a user actuated display element that uses the timing information to enable the user to navigate from an offset of one content segment to an offset of another content segment within the discrete media content in response to user actuation of the element.

5. The computerized method of claim 1 further comprising:
generating the search result to include the user actuated display element that uses the timing information to enables a user to navigate from an offset of one content segment to an offset of another content segment within the discrete media content in response to user actuation of the element.

6. The computerized method of claim 5 further comprising:
obtaining the metadata associated with the discrete media content that satisfies the search query, the corresponding timing information including offsets corresponding to each of the content segments within the discrete media content; and
adapting the user actuated display element to respond to user actuation of the element by causing playback of the discrete media content commencing at one of the content segments having an offset that is prior to or subsequent to the offset of a content segment in presently playback.

7. The computerized method of claim 1 wherein one or more of the content segments identified in the metadata include word segments, audio speech segments, video segments, non-speech audio segments, or marker segments.

8. The computerized method of claim 1 wherein one or more of the content segments identified in the metadata include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity.

9. The computerized method of claim 1 wherein one or more of the content segments identified in the metadata include video of individual scenes, watermarks, recognized objects, recognized faces, overlay text or video separated by markers embedded within the media content.

10. The computerized method of claim 2, wherein the metadata associates a confidence level with the transcription for each of the identified content segments, and the method further comprises:
generating the search result that includes transcriptions of one or more of the content segments identified in the metadata, such that each transcription having a confidence level that fails to satisfy a predefined threshold is displayed with one or more predefined symbols.

11. The computerized method of claim 2, wherein the metadata associates a confidence level with the transcription for each of the identified content segments, and the method further comprises:
ranking the search result based on a confidence level associated with the corresponding content segment.

12. The method of claim 1 further comprising downloading the search result to a client for presentation, further processing or storage.

13. A computerized method of presenting search results for media content, comprising:
presenting a search result that enables a user to arbitrarily select and commence playback of the discrete media content at any of the content segments of the discrete media content using timing offsets derived from the discrete media content using one or more automated media processing techniques.

14. The computerized method of claim 13, further comprising:
presenting the search result including transcriptions of one or more of the content segments of the discrete media content, each of the transcriptions being mapped to a timing offset of a corresponding content segment;
receiving a user selection of one of the transcriptions presented in the search result; and
causing playback of the discrete media content at a timing offset of the corresponding content segment mapped to the selected one of the transcriptions.

15. The computerized method of claim 13 wherein each of the transcriptions is derived from the discrete media content using one or more automated media processing techniques or obtained from closed caption data associated with the discrete media content.

16. The computerized method of claim 14 further comprising:
presenting the search result which further includes a user actuated display element that enables the user to navigate from an offset of one content segment to another content segment within the discrete media content in response to user actuation of the element.

17. The computerized method of claim 13 further comprising:
presenting the search result which includes a user actuated display element that enables the user to navigate from an offset of one content segment to another content segment within the discrete media content in response to user actuation of the element.

18. The computerized method of claim 17 further comprising:
obtaining timing offsets corresponding to each of the content segments within the discrete media content;
in response to an indication of user actuation of the display element, determining a playback offset associated with the discrete media content in playback;
comparing the playback offset with the timing offsets corresponding to each of the content segments to determine which of the content segments is presently in playback; and
causing playback of the discrete media content to continue at an offset that is prior to or subsequent to the offset of the content segment presently in playback.

19. The computerized method of claim 13 wherein one or more of the content segments identified in the metadata include word segments, audio speech segments, video segments, non-speech audio segments, or marker segments.

20. The computerized method of claim 13 wherein one or more of the content segments identified in the metadata include audio corresponding to an individual word, audio corresponding to a phrase, audio corresponding to a sentence, audio corresponding to a paragraph, audio corresponding to a story, audio corresponding to a topic, audio within a range of volume levels, audio of an identified speaker, audio during a speaker turn, audio associated with a speaker emotion, audio of non-speech sounds, audio separated by sound gaps, audio separated by markers embedded within the media content or audio corresponding to a named entity.

21. The computerized method of claim 13 wherein one or more of the content segments identified in the metadata include video of individual scenes, watermarks, recognized objects, recognized faces, overlay text or video separated by markers embedded within the media content.

22. The computerized method of claim 14, wherein each of the transcriptions is associated with a confidence level, and the method further comprises:
presenting the search result including the transcriptions of the one or more of the content segments of the discrete media content, such that any transcription that is associated with a confidence level that fails to satisfy a predefined threshold is displayed with one or more predefined symbols.

23. An apparatus for generating search results for media content, comprising:
means for obtaining metadata associated with a discrete media content that satisfies a search query, the metadata identifying content segments and corresponding timing information derived from the discrete media content using one or more automated media processing techniques; and
means for generating a search result that enables a user to arbitrarily select and commence playback of the discrete media content at any of the content segments using the corresponding timing information identified in the metadata.

24. An apparatus for presenting search results for media content, comprising:
means for presenting a search result that enables a user to arbitrarily select and commence playback of the discrete media content at any of the content segments of the discrete media content using timing offsets derived from the discrete media content using one or more automated media processing techniques.
